(19) United States
(12) Patent Application Publication
(10) Pub. No.: US 2003/0145132 A1
(43) Pub. Date: Jul. 31, 2003

(54) Cell software and process for installing it

(76) Inventor: Arvind Srinivasan, Mountain View, CA (US)

Correspondence Address: THEODORE JAY, SUITE 600, 16 N CHATSWORTH AVE, LARCHMONT, NY, 10538, US

(21) Appl. No.: 10/061,004

(22) Filed: Jan. 30, 2002

(51) Int. Cl. G06F 9/00; G06F 9/46; G06F 15/16

(52) U.S. Cl. 709/328; 709/318; 709/206

(57) ABSTRACT

An abstract information drop box which is addressable:via an email Address and can store a variety of structured and unstructured data and data types including Mails, Files, XML, and other data formats with data inside cell organized in folders.

### BACKGROUND OF THE INVENTION

The present invention is directed toward a new type of software, cell software, and a process for installing it in a suitable storage medium such as a server.

### SUMMARY OF THE INVENTION

Cell Definition

A cell is an abstract information drop box with the following properties:

1. It is addressable via an email Address;

2. It can store a variety of structured and unstructured data and data types including Mails, Files, XML, and other data formats; Data inside cell is organized in folders;

3. Data in the cell can have different storage life cycles;

4. Data can be stored, retrieved, removed and manipulated using a variety of different protocols;

5. It provides application services including event notification, calling registered event handles and forwarding of data;

6. It can be replicated and organized in a hierarchy or other relationships.

Cell Installation

In order to install a cell, the following information must be provided.

a. The email Address of the Cell

b. Parent Cell Address or Id

c. One or more cell Address or Id along with the relationship

d. Cell Type that specifies the following

i. Time To Live

ii. Needed Data Formats

iii. Accessibility options

e. Other Custom Cell requirements including data formats, accessibility, time to live etc.

(2) The cell creator connects to a cell storage medium such as a server using one of the protocols (API, Web Services, EJB/RMI, HTTP etc) and gives the information in (1) to create and install a cell. Also, a cell can be created via a Browser based interface or other GUI interface by providing the same information.

(3) Once the cell is created and installed, the cell is ready to accept information.

Installing Information in a Cell

(1) The Cell infrastructure software can accept data with in the cell via several protocols and they include HTTP, HTTPS, Web Services, Direct API (using local method calls or remote method calls such as RMI & EJB), SMTP, IMAP, WebDAV, Messaging Queue such as JMS etc.

(2) Data is accepted via the protocols mentioned in (1) and staged in a Staging area that is a combination of Database Store and File System Store. Depending on type of data, the staged data may be stored entirely in the Database or File System or a combination of the two.

(3) The Data Processing Unit (DPU) module with in the ZipLip software now processes the staged data. DPU looks at the incoming data properties:

a. Receiver Cell

b. Incoming data type

c. Incoming data Format

d. Other named attributes specified with in the incoming data

e. Source Name or Address

f. Source Type

The DPU uses these incoming properties to determine the Handler that will handle the incoming data. The Handler is the code that defines the “Processing Logic” for incoming data. The methodology of registering and programming handlers are defined in a later section. Note each data could be addressed to one or more cells. For each Cell Receiver step 4 is applied.

(4) Note this step is repeated for each cell receiver. The Handler applies the processing logic to the incoming and performs appropriate action to incoming including one or more of the following

a. Parses the incoming data depending on the data type

b. Verifies the integrity of data using industry standard Authentication, and Non-Repudiation algorithms.

c. Examines the contents for Virus and would take corrective action or ignore the data in the event of a virus

d. Examine contents and takes appropriate action (Content Filtering)

e. Converts the data from one format to another

f. Set the location with in the cell to be store (eg. Set folder information)

g. Encrypt the data

h. Store the processed information with in the cell at the location specified.

i. Relay raw or processed information to another cell Server

j. Relay raw or processed information as an email to another address

k. Relay raw or processed information to other application via appropriate protocols which includes HTTP, SMTP, Web Services, EJB/RMI/CORBA, Messaging Queue such as JMS, IMAP, Web-DAV, SMS.

l. Send Alerts as emails, SMS messages to handset and PDA.

m. Update the Status associated with this Cell as DONE, ABORTED or INPROGRESS.

(5) As a final step, the Post Handler examines all the cell recipient status and following actions are taken:

a. Verifies if all cell recipient status is done.

b. If all recipient are successfully completed, it marks the staged data for deletion and updates the closes the data transaction.

c. If one or more recipients are not done and all of them have permanent errors, then post handler would update the status, log the errors, and would close the data transaction.

d. If there are some temporary errors, the handler will determine whether the transaction has to retried and if so after how long.

(i) If it is to be retried, then task is scheduled with the scheduler to redone after the interval at which time only pending cell recipients are reprocessed.

(ii) If no more retries are needed, then appropriate logging is done and the transaction is closed. Also notification messages about the failure to process for certain recipient can be optionally sent using the various protocols (SMTP, HTTP et.al)

Retrieving and Manipulating Information from the Cell

In order to retrieve Information, the following steps are needed

1. The retrieving person or applications first is authenticated via several standard ways including such as user-id and password, digital certificates and other standard authentication mechanisms.

2. Once the user is authenticated, access is given to the information contained with in one or more cell that the user is authorized to.

3. For end user standard views of the information are available and some of the standard applications include

a. Viewing & Manipulating Mail Information within a cell from a standard Web-Mail interface.

b. Viewing & Manipulation Mail Information

c. Viewing Binary File storage via ZipLip Virtual Storage Web Application

d. Viewing Binary File storage, manipulate and organize them using WEB-DAV Viewers

e. Transform, format and present XML Data

4. Application can retrieve information in one more ways and some of them are

a. Retrieving meta-information about data contained with in folder of the particular data type.

b. Retrieving meta-information about data based on search criteria including date of creation, last access, state variables, source, content of the data itself.

c. Retrieve one or more information in the raw form using the meta-information.

d. Retrieve transformed or formatted information using the meta-information.

Managing Information with Cell (Deleting, Archiving)

1. Privileged users and applications can create a structure to store information and organize them in folders and sub folders. Human will use the available applications while the application may use any one the protocols that is appropriate (HTTP, IMAP, POP, EJB/RMI, Web-services et. al).

2. Privileged users or applications can create folders and subfolder to any depth for the particular type of data.

3. Privileged users or applications can move information across folders with in the cells.

4. Privileged users or applications can modify and update information of any particular item.

5. Privileged users or applications can move information from one cell to another.

6. Privileged users or applications can share of one or more pieces of data information with other cells.

7. Privileged users or applications can delete the information from the cell.

8. Privileged users or applications can grant access to cell information to other users and application

9. Cell can automatically reconfigure information based on policies set by privileged users or applications. Eg. Information beyond certain date will be automatically transferred to a different system, or for that matter to a different cell or to a different folder etc.

V. Life Span of the Cell

1. The cell itself can have limited or unlimited life. This can be set at the creation time or modified at later time by privileged users or applications.

2. When cell life expires, the information will either be purged or achieved depending on configuration.

3. Privileged users or application at any time during cell life may merge two cells in to merged cell.

4. Privilege users or application at any time may split the information with in one cell into multiple cells giving each one a separate identity.

5. Privileged user or application can terminate a cell at any time.

Methodology to Utilize Cell Services

Cell offers several services and these are broadly categorized as Storage Service, Presentation Service, Messaging Service and Application Service.

1. These services can be availed by adding information to the cell using its address as described in Section II.

2. The service request instructions are contained either in the incoming data or the handler handling the data would request the service. Services can be one time or recurring or scheduled.

3. The Cell together with the Cell system will perform the application service. Some application service are instantaneous (eg., Transforming data, or forwarding data),other services may take a long time (eg. Collecting time-sheet information from end user will have to wait till the end user responds to it).

4. Privileged Users and application can retrieve ongoing services associated with a cell or group of cells and monitor their status.

5. Privileged User and application can abort an ongoing service.

6. Once the service is complete or aborted, requesters may be notified via one of the many available methods (Email, Message Queue, EJB//RMI, SMS etc).

Programming DPU

A handler is a chain of one or more handlers that will process the incoming data and apply processing. Each basic handler will perform a functionality and set the states and data so that a subsequent handler can process it. Some Handler processing examples are

1. Virus Check

2. Content Filtering

3. User Authentication and Non Repudiation Verification

4. Data Transformation

5. Alerting

6. Storing of Information with in the cell

Typically these fundamental operations are applied in serial order and each handler can change state variable and pass information to next handler to modify the behavior of the downstream chain. For example

1. Data comes in and the sender is verified to be correct

2. Then a Virus check handler verifies for virus and if it find s virus, it set the Status state variable as DONE and action state-variable as VIRUS_BLOCK.

3. Subsequent handler will look at the state variable and will not do anything.

4. Post Handler Looks at this and would send a notification to the sender about the detection.

5. A Rule is created for (eg Source=xyz and dest CellType=“COLLAB”) and associated with the Handler Chain.

6. Incoming Data properties is used and a test is made if the rule is satisfied and if so the matching handler will be the processing Handler.

7. The Rule association can be configured during installation or during runtime by privileged users and applications.

### BRIEF DESCRIPTION OF THE DRAWINGS

FIG. 1 illustrates the cell and cell grid.

FIG. 2 illustrates the overall cell architecture

FIG. 3. Data Processing Unit

### DETAILED DESCRIPTION OF CELL ARCHITECTURE

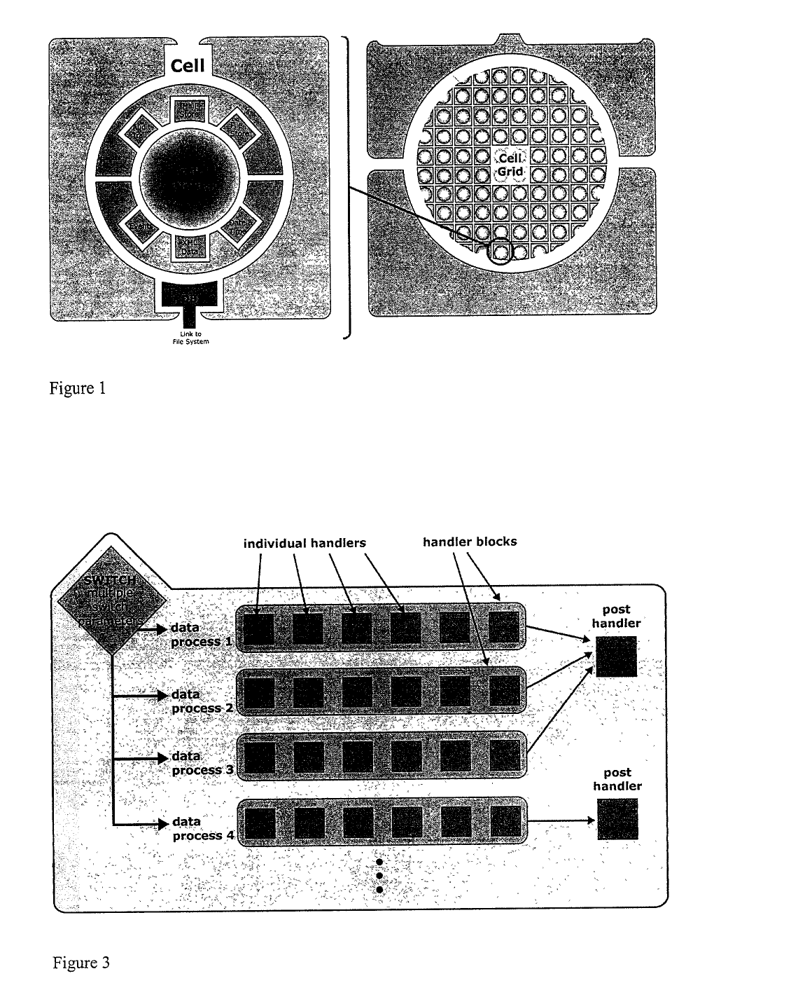

FIG. 1 displays a left hand section labeled as a cell and a right hand section as a cell grid. The cell grid contains a plurality of individual cells connected as a grid. A cell has a unique email address and this gives both internal and external addressability. In addition, the cell can have several unique aliases that can be either addressable internally or externally or both. A cell can represent animate things such as an individual, customer and inanimate things such as an inventory item, a machine, a customer complaint, car rental instance, air ticket etc. A cell can have several children cells and can maintain relationship with other cells. For example a cell representing a customer is related to cells representing customer complaint that was initiated by the customer.

Information can be added or delivered to the cell via various protocols such as API, Web Services, EJB/RMI, HTTP, SMTP, IMAP etc. This enables any user having an access to open standard based ubiquitously available applications such as Email, WEB-DAV to add information and issue commands to the cell from any where in the world. The cell is capable of storing both structured and unstructured data and data-types including Mails, Files, XML. The data with in cell is organized in the form of a tree structure also known as folders. Data with in the cell can be retrieved, reorganized (moved from one folder to another) and manipulated using standard applications or custom applications built on top of the Cell Storage system. Each piece of data with in the cell has a life cycle and this is usually based on the set of established policies. In addition, the life cycle of the data can be extended or reduced by various applications at any time.

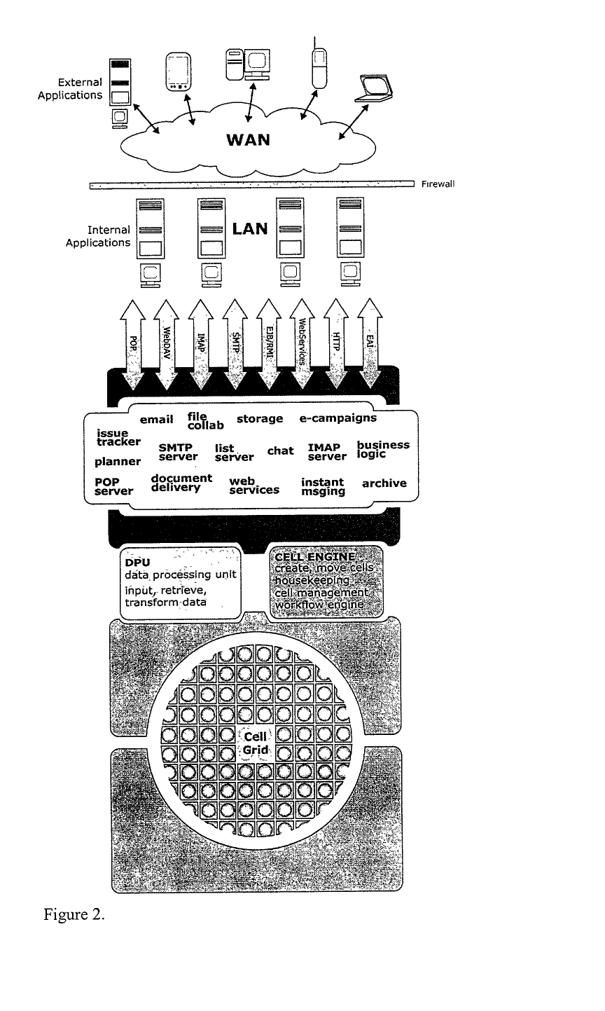

FIG. 2 depicts the overall cell architecture. The cell architecture can be broadly categorized into four components

(1) Cell Storage Module

(2) Data Processing Unit

(3) Cell Engine

(4) Cell Applications

Cell Storage Module:

The cell storage module is responsible for storing information with regards to cell. The storage module can store a variety of data formats including

a) Email Data

b) File Data

c) XML Data

d) Calendaring Data

e) Events & Command Data

f) Audit Trail Data

Each data format can be used by one or more applications, for eg. email data is used by email application, list server application, statement delivery application and so on. In the same way, file data can be used by virtual storage application to store binary data, issues tracker application, chat application etc. Each piece of information with in the cell has a a data format and application type associated with it. Any single unit of information within cell has one or both of the following components, a META-DATA component which is like a summary or the headers of the information and the ACTUAL-DATA, which is the complete information. The META-DATA of the information is stored in the database while the actual information depending on its size may be stored on the database or the file system. Depending on the security needs, the information may be encrypted before storing in the cell. A single cell may possess both encrypted and non-encrypted information. The information within the cell is usually organized in a tree structure also known as folders. The folders can be nested to any extent. The cell engine provides general functions for application to create, delete and rename folders. It also enables moving cell information from one folder to another.

Data Processing Unit:

The Data Processing Unit (DPU) is the module that performs additional pre-processing and post processing of incoming and outgoing cell data. This processing can be either synchronous or asynchronous. Inbound and outbound data are processed by the DPU. In order to process, the DPU uses a set of handler blocks which is a chain of handlers as shown in FIG. 3. Each handler defines a processing logic and uses the previous state set by prior handlers and process data before setting the states for the next handler in the chain to process. DPU chooses the correct handler block to process the inbound and outbound data by looking at the following properties of the data

a. Destination cell address or other external destinations address

b. Data type

c. Data format

d. Other named attributes specified with in the data

e. Source name or address

f. Source type

The handlers process the incoming data and some typical processing includes

a. Parses the incoming data depending on the data type

b. Verifies the integrity of data using industry standard authentication, and non-repudiation algorithms.

c. Examine contents for Virus and would take corrective action or ignore the data in the event of a virus. Note this handler may maintain a state and will perform this task for the first destination address and for the remaining of the destination addresses, it will use prior results thus minimizing the processing effort.

d. Examine contents and takes appropriate action (Content Filtering)

e. Converts the data from one format to another

f. Set the location with in the cell to be store (eg. Set folder information)

g. Encrypt the data

h. Store the processed information with in the cell at the location specified.

i. Relay raw or processed information to another cell server

j. Relay raw or processed information as an email to another address

k. Relay raw or processed information to other application via appropriate protocols and this includes HTTP, SMTP, Web Services, EJB/RMI/CORBA, Messaging Queue such as JMS, IMAP, Web-DAV, SMS.

l. Send alerts as emails, SMS messages to handset and PDA.

m. Update the status associated with this cell as DONE, ABORTED or INPROGRESS.

Thus the handler processes the incoming data and may convert data coming in one format and to another format. Eg: email sent from a external source can be parsed, authenticated and finally transformed to XML data and stored in with in the cell.

As a final step, the Post Handler examines all the cell recipient status and following actions are taken:

a. Verifies if all destination recipient status is done.

b. If all recipient are successfully completed, the post-handler closes the transaction and initiates necessary cleanup action.

c. If one or more recipients are not done and all of them have permanent errors, then post handler would update the status, log the errors, and would close the data transaction.

d. If there are some temporary errors, the handler will determine whether the transaction has to re-tried and if so after how long.

The DPU provides a reliable way to performing these processing in events of machine reboots, powered-down or hangs. The states associated with processing are stored persistently and could be resumed by the same or different machine; should the processing machine get rebooted, powered-down or simply hangs.

Thus the DPU provides a programmable, flexible and a reliable method to apply processing on incoming and outgoing data.

Cell Engine

The cell engine gives life to the data stored with cell store. The cell engine is responsible for generation of events, event notification, calling registered event. The cell engine also provides Application Programming Interfaces (API) to allow manipulation of information and general housekeeping activities. The cell engine can maintain some of its states persistently in the database and file store and is reliable with respect to machine reboots, power-downs and hangs. The cell engine also encompasses a work flow Engine to specify and execute the data-management behavior with in the cell.

Cell Applications:

The cell applications provide the high level services, enable external communication with other external applications and humans over various protocols. The application enables addition, deletion and modification of information with in the cell by working with the other three modules Cell Store, DPU and the Cell Engine. The applications also are responsible for building and managing and enforcing access privileges for various external application and humans and it performs this task by working with cell store and the cell engine. Application can be simple TCP/IP server (eg. SMTP Server application), Client-Server (eg. WEB-DAV virtual Storage server), or be completely a web-based application (eg. WEB-MAIL, Web-based Issues tracker). Applications typically have its information stored in the cell store in one or more formats and is solely responsible to manage the same. Some applications may not have direct association with cell store and they work directly as a communication channel with the DPU or the cell engine. An example is the SMTP Server application. It receives information via SMTP protocol and stages the data and informs the DPU to process the data. Some of the standard cell applications are

a) Email Application—Create, store and manage mails associated with a cell.

b) Virtual Storage Application—For storing and retrieving and collaborating binary files associated with a cell.

c) SMTP Server Application—A communication application, for both inbound and outbound. DPU utilizes this application to offer SMTP communication services to other applications.

d) POP Server Application—A communication application, typically used by email epplication to give end user access to inbox of the cell.

e) IMAP Server Application—A communication typically used by email application to give access and manage cell email data.

f) Web-Services Application—A communication application that receives commands via Web-Services and transfers the request to the appropriate application or to DPU.

g) Issues Tracker Application—Create and track issues relevant to cell.

h) List Server Application—Distribute information from the cell to a mailing list.

i) Planner Application—Maintain appointments, to do list and reminders with in the cell.

j) Form Filling Application—Collect information from the end user by presenting a web form and store the result inside the cell.

k) Document Delivery Application—Delivery documents to and from cell.

l) Instant Messaging Application—enable instant messaging between two humans identified by their cell.

m) Chat Application—enable chat between two cell identified by their cell.

n) Campaign & Statement Delivery Application—Distribute cell information to external applications or humans.

What is claimed is:

1. An abstract information drop box defined as a cell with the following properties:
[a] it is addressable via an email Address;
[b] it can store a variety of structured and unstructured data and data types including Mails, Files, XML, and other data formats with data inside cell organized in folders;
[c] data in the cell can have different storage life cycles;
[d] data can be stored, retrieved, removed and manipulated using a variety of different protocols;
[e] it provides application services including event notification, calling registered event handles and forwarding of data; and
[f] can be replicated and organized in a hierarchy or other relationships.

2. A plurality of cells as defined in claim 1 and arranged and connected as a grid.
